(19) United States
(12) Patent Application Publication
(10) Pub. No.: US 2004/0064416 A1
(43) Pub. Date: Apr. 1, 2004

(54) Secure distribution of digital content

(76) Inventors: Ariel Peled, Even-Yehuda (IL); Oren Tirosh, Hod Hasharon (IL); Assaf Litai, Kfar Saba (IL); Arik Baratz, Hadera (IL); Lidror Troyansky, Givataim (IL)

Correspondence Address: G E Ehrlich, Anthony Castorina, 2001 Jefferson Davis Highway, Suite 207, Arlington, VA, 22202, US

(21) Appl. No.: 10/398,192

(22) PCT Filed: Oct. 1, 2001
(86) PCT No.: PCT/IL01/00916

(51) Int. Cl. G06F 17/60

(52) U.S. Cl. 705/51; 705/57

(57) ABSTRACT

A method for secure distribution of digital content (108), the method including the steps of dividing a unit of digital content into at least first and second portions (200), storing the first portion on a first computerized apparatus, digitally watermarking the second portion, and combining the first portion and the digitally watermarked second portion, thereby forming a watermarked (106) version of the digital content.

### CROSS-REFERENCE TO RELATED APPLICATIONS

This application is related to and claims priority from U.S. Provisional Patent Application No. 60/240,739 filed Oct. 17, 2000, to Applicant Ariel Peled, et al., also U.S. Provisional Patent Application No. 60/237,190 filed Oct. 3, 2000, U.S. patent application Ser. No. 09/722,538 filed Nov. 28, 2000, and U.S. patent application Ser. No. 09/761,149 filed Jan. 17, 2001. All of the above applications are incorporated herein by reference in their entirety.

### FIELD OF INVENTION

The present invention relates in general to digital content distribution systems and methods and anti-piracy methods, and more particularly but not exclusively to a digital content distribution system that provides watermarked content so that illegal distribution can be traced.

### BACKGROUND OF THE INVENTION

Systems and methods for distribution of digital content to end-users are well known. In one such system, identical copies of digital content are distributed by a content server via a computer network, such as the Internet, to one or more proxy servers. An end-user requesting digital content from the content server may then be redirected to a proxy server that is nearer to the end-user than is the content server. The proxy server then distributes the digital content to the end-user more quickly and efficiently than would the content server, as the content has less far to travel.

Methods for anti-piracy protection of digital content are also well known. In one such method, a digital watermark that is uniquely associated with a particular end-user is embedded into the digital content at the content server prior to distribution to the end-user. The network is then monitored for unauthorized redistribution of the digital content to other end-users.

While it would be advantageous to combine methods of efficient distribution of digital content with anti-piracy methods that employ digital watermarking, current proxy server-based distribution methods require that all copies of digital content that are distributed from each of the proxy servers be identical, while digital watermarking methods often require that unique variants of the original content be created. Clearly, the storage of each variant on every proxy server would be inefficient and impractical, if not impossible.

Some prior art systems attempt to solve this problem by distributing identical copies of digital content to proxy servers and end-users, and embedding the digital watermark into the digital content at the end-user's receiving apparatus. However, this approach does not provide an adequate level of security as the receiving apparatus may be tampered with and, therefore, cannot be trusted to perform the embedding of the watermark.

The following U.S. Patents are believed to be representative of the current state of the art of digital watermarking techniques: U.S. Pat. Nos. 5,809,139, 5,915,027, 5,960,081, 6,069,914, 6,131,161, 6,278,792, 6,266,430 and 6,246,775.

The disclosures of all patents, patent applications, and other publications mentioned in this specification and of the patents, patent applications, and other publications cited therein are hereby incorporated by reference.

### SUMMARY OF THE INVENTION

The present invention seeks to provide a novel method of secure distribution of digital content. Original content such as a video content, audio content, or other digitally-encoded content is split into at least two portions of substantially unequal size, with one or both portions preferably being crippled or disabled. Identical copies of the larger part are distributed to proxy servers using any known distribution means. The smaller part can then be uniquely watermarked and recombined with the larger part at a remote site, such as at the proxy server or at the end-user's receiving apparatus, thereby creating a usable copy of the digital content. The present invention is advantageous in that it provides for unique watermarking of digital content in conjunction with proxy-server based distribution networks optimized for storing and delivering identical copies of digital content. The system can also be used in order to elevate the general level of security in systems for distribution of digital content.

There is thus provided in accordance with a preferred embodiment of the present invention a method for secure distribution of digital content, the method including the steps of dividing a unit of digital content into at least first and second portions, storing the first portion on a first computerized apparatus, digitally watermarking the second portion, possibly storing the digitally watermarked second portion on a second computerized apparatus, and combining the first portion and the digitally watermarked second portion, thereby forming a watermarked version of the digital content.

In another aspect of the present invention the dividing step includes dividing the digital content into at least first and second portions, where each of the portions includes non-contiguous segments of the digital content.

In another aspect of the present invention the dividing step includes dividing the digital content into at least portions of a first kind and portions of a second kind, wherein the portions of the first kind are larger than the portions of the second kind.

In another aspect of the present invention the dividing step includes dividing the digital content such that a qualitative measure of either of the portions of the first and second kinds is degraded relative to a corresponding qualitative measure of the digital content as a whole, thereby to ensure that the two kinds cannot respectively be used alone. In a preferred embodiment one of the kinds can be used with a degraded placeholder for the other kind.

In another aspect of the present invention the dividing step includes dividing the digital content such that either of the portions of the first and second kinds are individually inoperable.

In another aspect of the present invention the storing of the first portion kind includes storing on a proxy server.

In another aspect of the present invention the digitally watermarking step includes uniquely watermarking the second portion kind.

In another aspect of the present invention the method further includes the steps of receiving a request from a requestor for the digital content, and sending the watermarked version of the digital content to the requester.

In another aspect of the present invention the combining step includes combining at either of the computerized apparatus.

In another aspect of the present invention the combining step includes sending the portions to a third computerized apparatus and combining at the third computerized apparatus.

There is also provided in accordance with a preferred embodiment of the present invention a method for secure distribution of digital content, the method including the steps of dividing a unit of digital content into at least first and second portions, where the first portion is larger than the second portion, and where the dividing step includes either of dividing the digital content such that a qualitative measure of either of the first and second portions is degraded relative to a corresponding qualitative measure of the digital content, and dividing the digital content such that either of the first and second portions are individually inoperable, storing the first portion on a first computerized apparatus, storing the second portion on a second computerized apparatus, and combining the first portion and the second portion, thereby recreating the digital content.

In another aspect of the present invention the dividing step includes dividing the digital content into at least first and second portions, where each of the portions includes non-contiguous segments of the digital content.

In another aspect of the present invention the storing of the first portion step includes storing on a proxy server.

In another aspect of the present invention the method further includes the steps of receiving a request from a requestor for the digital content, and sending the recreated digital content to the requestor.

In another aspect of the present invention the combining step includes combining at either of the computerized apparatus.

In another aspect of the present invention the combining step includes sending the portions to a third computerized apparatus and combining at the third computerized apparatus.

There is additionally provided in accordance with a preferred embodiment of the present invention a system for secure distribution of digital content, the system including means for dividing a unit of digital content into at least first and second portions, means for storing the first portion on a first computerized apparatus, means for digitally watermarking the second portion, means for storing the digitally watermarked second portion on a second computerized apparatus, and means for combining the first portion and the digitally watermarked second portion, thereby forming a watermarked version of the digital content.

In another aspect of the present invention the means for dividing is operable to divide the digital content into at least first and second portion kinds, where each of the portion kinds respectively includes non-contiguous segments of the digital content.

In another aspect of the present invention the means for dividing is operable to divide the digital content into at least first and second portion kinds, where the first portion kind is larger than the second portion kind.

In another aspect of the present invention the means for dividing is operable to divide the digital content such that a qualitative measure of either of the first and second portion kinds is degraded relative to a corresponding qualitative measure of the digital content.

In another aspect of the present invention the means for dividing is operable to divide the digital content such that either of the first and second portion kinds are individually inoperable.

In another aspect of the present invention the means for storing the first portion kind is operative to store on a proxy server.

In another aspect of the present invention the means for digitally watermarking is operative to uniquely watermark portions of the second kind.

In another aspect of the present invention the system further includes means for receiving a request from a requestor for the digital content, and means for sending the watermarked version of the digital content to the requestor.

In another aspect of the present invention the means for combining is operative to combine at either of the computerized apparatus.

In another aspect of the present invention the means for combining is operative to send the portions to a third computerized apparatus and combine at the third computerized apparatus.

There is also provided in accordance with a preferred embodiment of the present invention a system for secure distribution of digital content, the system including means for dividing a unit of digital content into at least first and second portions, where the first portion is larger than the second portion, the means for dividing being operative to either of divide the digital content such that a qualitative measure of either of the first and second portions is degraded relative to a corresponding qualitative measure of the digital content, and divide the digital content such that either of the first and second portions are individually inoperable, means for storing the first portion on a first computerized apparatus, means for storing the second portion on a second computerized apparatus, and means for combining the first portion and the second portion, thereby recreating the digital content.

In another aspect of the present invention the means for dividing is operative to divide the digital content into at least first and second portions, where each of the portions includes non-contiguous segments of the digital content.

In another aspect of the present invention the means for storing the first portion is operative to store on a proxy server.

In another aspect of the present invention the system further includes means for receiving a request from a requestor for the digital content, and means for sending the recreated digital content to the requestor.

In another aspect of the present invention the means for combining is operative to combine at either of the computerized apparatus.

In another aspect of the present invention the means for combining is operative to send the portions to a third computerized apparatus and combine at the third computerized apparatus.

In a preferred embodiment, combinations taken from a finite set of individual watermarks may be inserted to provide unique content marking, as discussed in applicant's copending application U.S. Ser. No. 09/722,538 filed Nov. 28, 2000, the contents of which are hereby incorporated by reference.

In a further preferred embodiment of the present invention the techniques used herein may be used to provide personalized encryption, and reference is hereby made to U.S. patent application Ser. No. 60/283,949 filed Apr. 17, 2001, the contents of which are hereby incorporated by reference.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a system for secure distribution of digital content, constructed and operative in accordance with a preferred embodiment of the present invention;

FIG. 2 is a simplified flowchart illustration of a method of operation of the system of FIG. 1, operative in accordance with a preferred embodiment of the present invention;

FIG. 3 is a simplified pictorial illustration of digital content in various states and stages in accordance with the application of the method of FIG. 2;

FIG. 4 is a simplified conceptual illustration of a system for secure distribution of digital content, constructed and operative in accordance with a preferred embodiment of the present invention;

FIG. 5 is a simplified flowchart illustration of a method of operation of the system of FIG. 4, operative in accordance with a preferred embodiment of the present invention; and

FIGS. 6 and 7, which are simplified flowchart illustrations of methods of operation of the systems of FIGS. 1 and 4 respectively, operative in accordance with a preferred embodiment of the present invention.

### DETAILED DESCRIPTION OF PREFERRED EMBODIMENTS

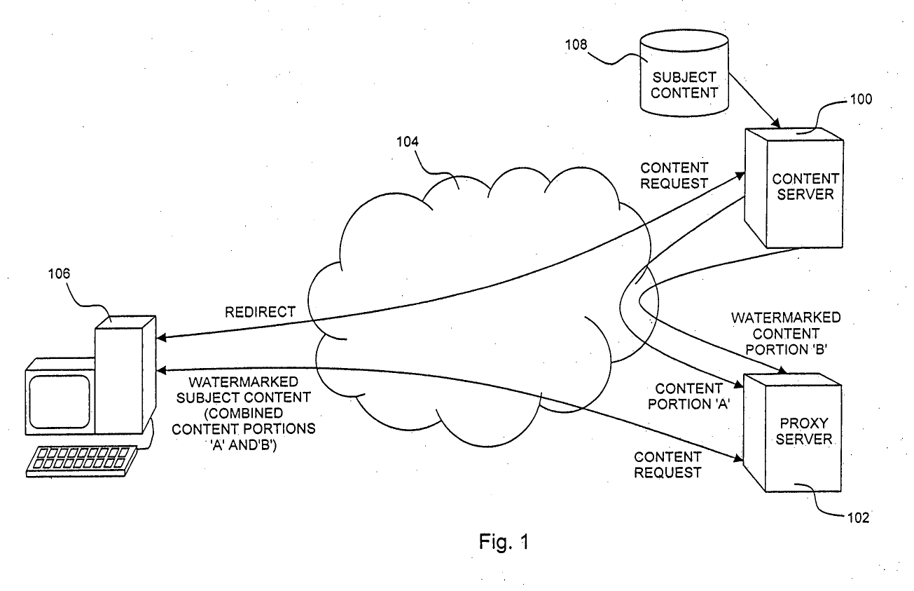

Reference is now made to FIG. 1, which is a simplified conceptual flow illustration of a system for secure distribution of digital content, constructed and operative in accordance with a preferred embodiment of the present invention. In the system of FIG. 1 a first computerized apparatus, such as a content server 100, on which digital content is stored, divides a unit of digital content, hereinafter referred to as subject content 108, into at least two content portions ‘A’ and ‘B’ and sends content portion ‘A’ to one or more other computerized apparatus, such as proxy servers 102, typically via a network 104, such as the Internet, with content portion ‘A’ being stored on proxy server 102 for later distribution. An end-user at a receiving apparatus 106, for example any computerized apparatus including a personal computer or a set-top box capable of connecting to network 104 for the purpose of data transmission, typically requests the subject content from content server 100, which then redirects receiving apparatus 106 to request the subject content from proxy server 102, with proxy server 102 typically being nearer to receiving apparatus 106 than is content server 100. Content server 100 then digitally watermarks content portion ‘B’ using any known digital watermarking technique or takes a pre-watermarked portion, preferably uniquely watermarking content portion ‘B’ for exclusive association with the requesting end-user using preferably authenticated identification information provided by the end-user. Content server 100 then sends the watermarked portion ‘B’ to proxy server 102. When receiving apparatus 106 requests the subject content from proxy server 102, proxy server 102 combines content portion ‘A’ with watermarked content portion ‘B’, resulting in a watermarked version of the original subject content which proxy server 102 then sends to receiving apparatus 106.

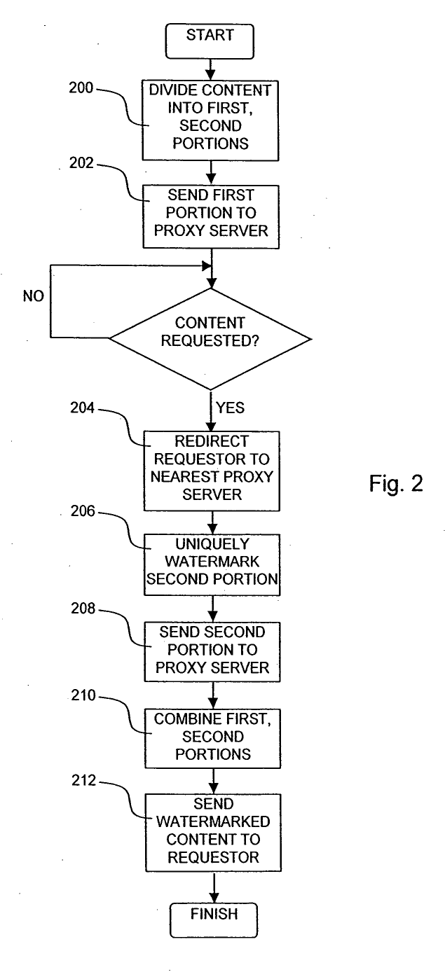

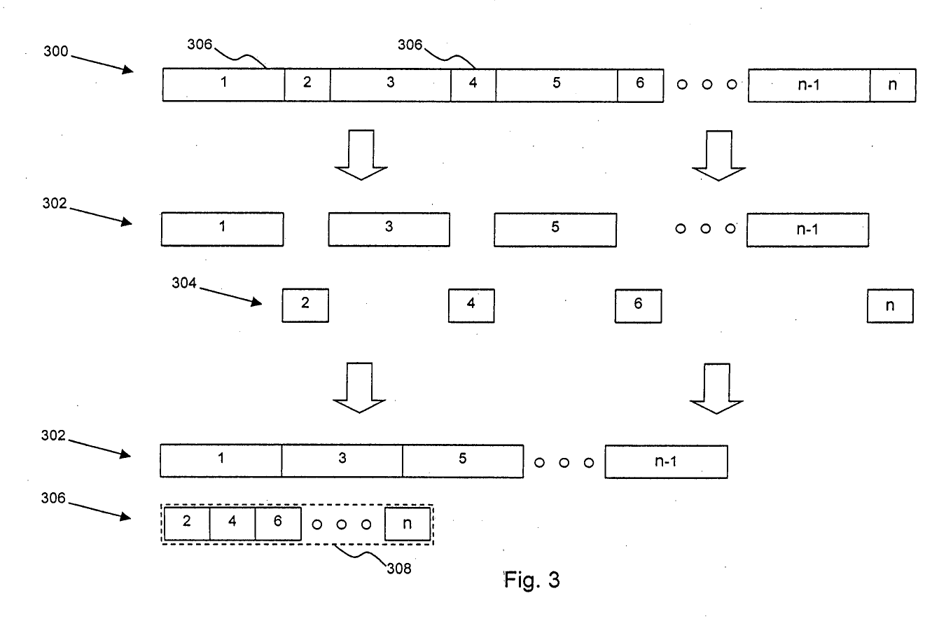

Reference is now made to FIG. 2, which is an simplified flowchart illustration of a method of operation of the system of FIG. 1, operative in accordance with a preferred embodiment of the present invention, and additionally to FIG. 3, which is a simplified pictorial illustration of digital content in various states and stages in accordance with the application of the method of FIG. 2. In the method of FIG. 2 a unit of digital content, generally designated 300, is divided into at least a first content portion, generally designated 302, and a second content portion, generally designated 304 (step 200). The division of content 300 may take place on a computer, such as content server 100 (FIG. 1), that is publicly accessible via a network, such as the Internet, or, preferably, on a computer to which access is limited to authorized users only and, most preferably, which is not accessible via the network. Preferably, content portion 302 is significantly larger than content portion 304, and each portion is preferably constructed from non-contiguous segments 306 of content 300. Content portion 302 is then placed onto a network-connected computer, if it is not already on one, and is sent, preferably encrypted and/or digitally watermarked using conventional techniques, via network 104 to one or more proxy servers 102 for storage thereat (step 202).

Upon receiving a request for content 300, at content server 100 or at another request server assigned to handle content requests, the requestor is typically redirected to the nearest proxy server (step 204). Content portion 304 is then digitally watermarked using conventional techniques (step 206), preferably being uniquely watermarked for unique association with the requestor, such as by incorporating an identification of the requester into the watermark. Content portion 304, now watermarked and shown as watermarked content portion 306 with the watermark conceptually represented by dashed lines 308, is then placed onto a network-connected computer, if it is not already on one, such as content server 100, and is sent, preferably encrypted, via network 104 to the proxy server 102 to which the requestor was redirected (step 208). Content portions 302 and 306 are then combined at proxy server 102 to form a watermarked version of the original subject content (step 210), which is then sent to the requestor (step 212).

The division of content 300 may be carried out in any number of ways, but is preferably done such that each portion is, by itself, crippled or rendered inoperable. A portion is said to be crippled if a qualitative measure of the portion, using any conventional quality measurement technique, is degraded relative to a corresponding qualitative measure of the original subject content. For example, salient portions of the content, whose removal will greatly reduce the quality of the content, may be removed from the content to form the smaller content portion that is to be uniquely watermarked. Where the content includes both video and audio elements, the audio bitstream may be separated from the original content to form the smaller content portion. Where the content is compressed and encoded using standards such as MPEG-2 or MPEG-4, discrete elements of the encoded content, such as “I-frames,” may be removed from the original content to form the smaller content portion, with one or more of the I-frames preferably bearing the unique watermark using conventional still image watermarking techniques. Global luminescence attributes or global motion vectors may be removed from video content to form the smaller content portion. Where the content has undergone coding such as Discrete Cosine Transform (DCT) coding, some or all of the DC coefficients and/or DCT coefficients of the frames vector may be removed to form the smaller content portion.

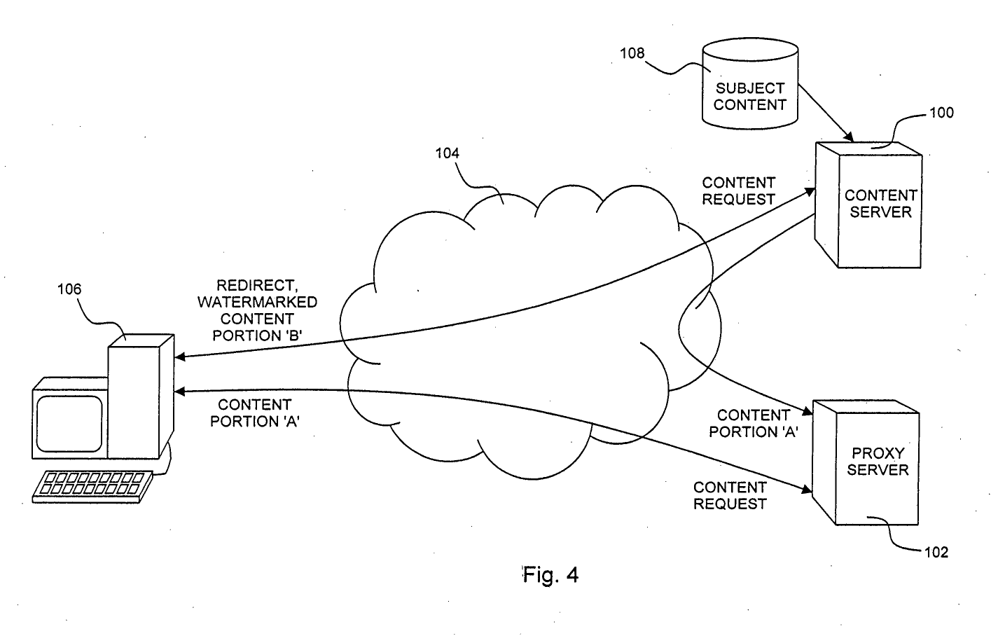

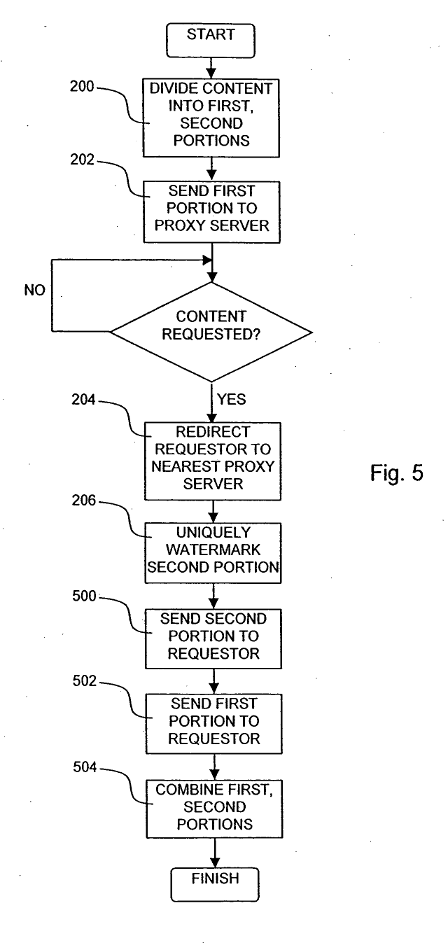

Reference is now made to FIG. 4, which is a simplified conceptual flow illustration of a system for secure distribution of digital content, constructed and operative in accordance with a preferred embodiment of the present invention, and additionally to FIG. 5, which is an simplified flowchart illustration of a method of operation of the system of FIG. 4, operative in accordance with a preferred embodiment of the present invention. The system of FIG. 4 and method of FIG. 5 are substantially similar to the system of FIG. 1 and method of FIG. 2 (including identical reference numerals for elements in common) with the notable exception that content server 100 digitally watermarks content portion ‘B’ and sends it directly to receiving apparatus 106 when the latter requests the subject content from content server 100, rather than sending watermarked content portion ‘B’ to proxy server 102 (step 500). Proxy server 102 separately sends content portion ‘A’ to receiving apparatus 106 (step 502), which then combines content portion ‘A’ with watermarked content portion ‘B’, resulting in a watermarked version of the original subject content (step 504).

In another embodiment of the present invention several proxies are involved in providing portions of either kind.

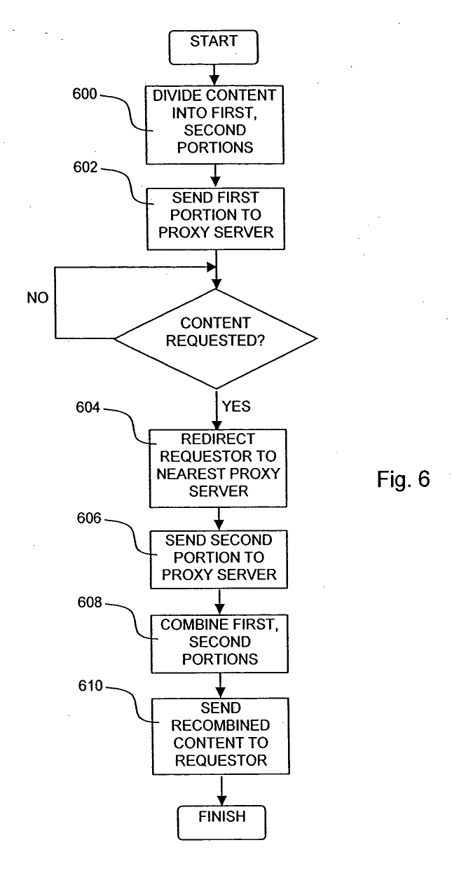

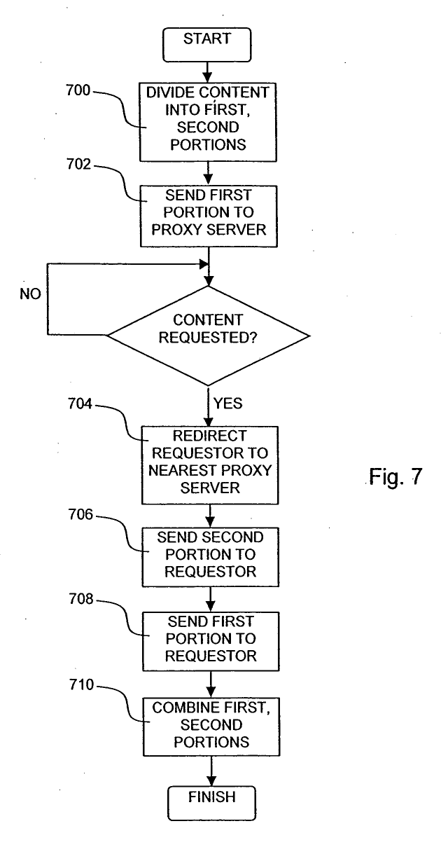

Reference is now made to FIGS. 6 and 7, which are simplified flowchart illustrations of methods of operation of the systems of FIGS. 1 and 4 respectively, operative in accordance with a preferred embodiment of the present invention. The methods of FIGS. 6 and 7 are substantially similar to the methods of FIGS. 2 and 5 respectively, and parts that appear in earlier figures are given the same reference numerals and are not discussed in detail again except as needed for an understanding of the present embodiment. The present embodiment differs in that the original subject content is divided such that the second portion, and preferably both portions, are individually crippled or rendered inoperable, and neither portion is uniquely digitally watermarked. In both methods the second portion is substantially smaller than the first portion as well. In FIG. 6 the smaller content portion is combined with the larger content portion at the proxy server, and the combined content is sent to the requester. In FIG. 7 the smaller and larger portions are separately sent to the requester and combined after receipt at the requestor. Reference is hereby made to applicant's copending application U.S. Ser. No. 60/263,233 filed Jan. 23, 2001, in which reference is made to the use of splitting of data content in order to increase the security of the data path. The content of that application is hereby incorporated herein by reference.

It is appreciated that one or more steps of any of the methods described herein may be implemented in a different order than that shown while not departing from the spirit and scope of the invention.

While the present invention may or may not have been described with reference to specific hardware or software, the present invention has been described in a manner sufficient to enable persons having ordinary skill in the art to readily adapt commercially available hardware and software as may be needed to reduce any of the embodiments of the present invention to practice without undue experimentation and using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. Apparatus for efficient and traceable distribution of digital content, the apparatus comprising:
a content divider for dividing digital content into parts of a first kind and parts of a second kind,
a first content part distributor for distributing parts of said first kind for easy access a content watermarked for inserting unique digital indicators into parts of said second kind per a request for said content, and
a second content part distributor for distributing parts of said second kind per said request for association with parts of said first kind, thereby to distribute combined parts of said first and second kinds as reconstituted uniquely indicated digital content.

2. Apparatus according to claim 1, wherein said parts of said first kind are for distribution to easily accessible locations on a network and wherein said parts of said second kind are for rapid distribution on demand from a predetermined single network location.

3. Apparatus according to claim 2, wherein said parts of a first kind are substantially larger than said parts of said second kind.

4. Apparatus according to claim 3, wherein said content divider is operable to select said parts of said second kind such that said parts of said first kind show quality degradation when used without said parts of said second kind.

5. Apparatus according to claim 3, wherein said content divider is operable to select for said second kind, any content portion of a group comprising motion data, color data, and sound data.

6. Apparatus according to claim 3, wherein said content divider is operable to select for each of said kinds, non-contiguous data sections of said content.

7. Apparatus according to claim 1, said uniquely indicated digital content being usable with a marking detector to provide digital rights management of said content.

8. A method for secure distribution of digital content, the method comprising the steps of:
dividing a unit of digital content into at least one portion of a first kind and at least one portion of a second kind;
storing said at least one portion of a first kind on a first computerized apparatus;
digitally watermarking said at least one portion of a second kind;
storing said digitally watermarked portion of a second kind on a second computerized apparatus; and
combining said portion of a first kind and said digitally watermarked portion of a second kind, thereby forming a watermarked version of said digital content.

9. A method according to claim 8 wherein said dividing step comprises dividing said digital content into said kinds of portions such that each of said portions comprises non-contiguous segments of said digital content.

10. A method according to claim 8 wherein said dividing step comprises dividing said digital content into said portions, such that said portions of a first kind are larger than said portions of a second kind.

11. A method according to claim 8 wherein said dividing step comprises dividing said digital content such that a qualitative measure of either of said portion kinds is degraded relative to a corresponding qualitative measure of said digital content.

12. A method according to claim 8 wherein said dividing step comprises dividing said digital content such that either of said portion kinds taken alone are individually inoperable.

13. A method according to claim 8 wherein said storing said portion of a first kind comprises storing on a proxy server.

14. A method according to claim 8 wherein said digitally watermarking comprises uniquely watermarking said portion of a second kind.

15. A method according to claim 8 and further comprising the steps of:
receiving a request from a requestor for said digital content; and
sending said watermarked version of said digital content to said requestor.

16. A method according to claim 8 wherein said combining step comprises combining at either of said computerized apparatus.

17. A method according to claim 8 wherein said combining step comprises sending said portions to a third computerized apparatus and combining at said third computerized apparatus.

18. A method for secure distribution of digital content, the method comprising the steps of:
dividing a unit of digital content into at least portions of a first kind and portions of a second kind, wherein said portions of a first kind are larger than said portions of a second kind, and wherein said dividing step comprises at least one of:
dividing said digital content such that a qualitative measure of either of said portions of said first kind and said portions of said second kind are degraded relative to a corresponding qualitative measure of said digital content, and
dividing said digital content such that either of said portions of said first kind and portions of said second kinds are individually inoperable;
storing said portion of said first kind on a first computerized apparatus;
storing said portion of said second kind on a second computerized apparatus; and
combining said portions of said first kind and said portions of said second kind, thereby recreating said digital content.

19. A method according to claim 18 wherein said dividing step comprises dividing said digital content into at least portions of said first and second kinds, wherein each of said portions comprises non-contiguous segments of said digital content.

20. A method according to claim 18 wherein said storing said portion of a first kind step comprises storing on a proxy server.

21. A method according to claim 18 and further comprising the steps of:
receiving a request from a requestor for said digital content; and
sending said recreated digital content to said requestor.

22. A method according to claim 18 wherein said combining step comprises combining at either of said computerized apparatus.

23. A method according to claim 18 wherein said combining step comprises sending said portions to a third computerized apparatus and combining at said third computerized apparatus.

24. A system for secure distribution of digital content, the system comprising:
a content divider for dividing a unit of digital content into at least portions of a first kind and portion of a second kind;
a first storage device for storing said portions of a first kind on a first computerized apparatus;
a watermarking unit for digitally watermarking said portions of a second kind;
a second storage device for storing said digitally watermarked portions of a second kind on a second computerized apparatus; and
a combiner for combining said portion of a first kinds and said digitally watermarked portion of a second kinds, thereby forming a watermarked version of said digital content.

25. A system according to claim 24 wherein said content divider is operable to divide said digital content into said portion kinds, such that each of said portions comprises non-contiguous segments of said digital content.

26. A system according to claim 24 wherein said content divider is operable to divide said digital content into at least said first and second portion kinds, and wherein said portion of a first kind is larger than said portion of a second kind.

27. A system according to claim 24 wherein said content divider is operable to divide said digital content such that a qualitative measure of either of said portion kinds is degraded relative to a corresponding qualitative measure of said digital content.

28. A system according to claim 24 wherein said content divider is operable to divide said digital content such that either of said portion kinds are individually inoperable.

29. A system according to claim 24 wherein said first storage device is located on a proxy server.

30. A system according to claim 24 wherein said watermarking unit is operative to uniquely watermark said portion of a second kind.

31. A system according to claim 24 and further comprising:
a request receiver for receiving a request from a requester for said digital content; and
a content sender for sending said watermarked version of said digital content to said requester.

32. A system according to claim 24 wherein said combiner is operative to combine at either of said computerized apparatus.

33. A system according to claim 24 wherein said combiner is operative to send said portions to a third computerized apparatus and combine at said third computerized apparatus.

34. A method for secure distribution of digital content, the method comprising the steps of:
dividing a unit of digital content into at least portions of a first kind and portions of a second kind;
storing said portion of a first kind on a computerized apparatus;
storing said portion on a computerized apparatus; and
combining said portion of a first kind and said portion of a second kind, thereby to form an operable version of said digital content.

35. A method according to claim 29, wherein said dividing is carried out such as to ensure that said portion of a first kind is larger than said portion of a second kind, said dividing comprising at least one of:
dividing said digital content such that a qualitative measure of either of said portion kinds is degraded relative to a corresponding qualitative measure of said digital content, and
dividing said digital content such that either of said portion kinds are individually inoperable; and
storing said portion of a first kind on a first computerized apparatus.

36. A method according to claim 29 wherein each of said portion kinds comprises non-contiguous segments of said digital content.

37. A method according to claim 29 comprising storing said portion of a first kind on a proxy server.

38. A method according to claim 29 and further comprising:
receiving a request from a requester for said digital content; and
sending said recreated digital content to said requestor.

39. A method according to claim 29 being operative to combine at either of said computerized apparatus.

40. A method according to claim 29 comprising sending said portions to a third computerized apparatus and combining at said third computerized apparatus.
